(19) United States
(12) Patent Application Publication
(10) Pub. No.: US 2005/0177417 A1
(43) Pub. Date: Aug. 11, 2005

(54) Point server system using serial numbers

(76) Inventor: Koji Koreyasu, Tokyo (JP)

Correspondence Address: BROWN & MICHAELS, PC;400 M & T BANK BUILDING, 118 NORTH TIOGA ST, ITHACA, NY, 14850, US

(21) Appl. No.: 10/489,489

(22) PCT Filed: Mar. 19, 2002
(86) PCT No.: PCT/JP02/02629

(30) Foreign Application Priority Data
Apr. 13, 2001 (JP) 2001-114841

(51) Int. Cl. G06F 17/60

(52) U.S. Cl. 705/14

(57) ABSTRACT

A server system connectable to a computer network and accessed by way of a user terminal for connecting to the computer network includes a user information database for storing user information, including personal information for a user and point information, and a point information database for storing point information specified for individual products and services; a serial number which is input and sent, using serial number input means, provided in the user terminal for inputting serial numbers assigned to individual products, services or the like, is received, and user authentication processing and serial number analysis processing are performed; the point information database is referenced, and the points corresponding to the corresponding product, service or the like are determined based on analysis of the serial number, and processing is performed to add the determined number of points to the point information in the user information database, to enable point shopping.

### REFERENCE TO RELATED APPLICATIONS

This application claims an invention which was disclosed in PCT Application Number PCT/JP02/02629, filed Mar. 19, 2002, entitled “POINT SYSTEM SERVER USING SERIAL NUMBERS”, which claimed priority from Japanese application 2001-114841, filed Apr. 13, 2001. The benefit under 35 USC §365 and 35 USC 119(a) of the PCT and Japanese applications are hereby claimed, and the aforementioned applications are hereby incorporated herein by reference.

### BACKGROUND OF THE INVENTION

1. Field of the Invention

The present invention relates to a point server system, which uses serial numbers that are assigned to individual products, services, or the like, and performs processing which adds points corresponding to this product, service or the like to the point information in a user information database, so as to make point shopping possible.

2. Description of Related Art

Conventionally, coupons were issued for discounts at electronic transaction sites using the Internet in the same way as for ordinary stores, and consumers were assigned points according to purchasing performance.

For example, the system disclosed in JP 2000-268094-A, “Product Point Management System,” provides a product point management system which makes maximum use of the advantages of product points so as to promote the introduction of online sales for a store and product purchases by users.

The system is such that, when a user purchases a product by way of a user terminal, based on product information that is input from a store terminal and supplied by a product point management server, product points that are issued to the user are managed for each transaction as point-issue information, which includes a sales transaction code, and product points that are used by the user are managed for each transaction as point-usage information, which includes the sales transaction code, whereby issued product points themselves and used product points themselves can be treated separately for each transaction and can be given assignability, whereby the sales outlet is able to grasp the details of the product-point usage situation based on the point-issue information and the point-usage information.

However, with the various conventional point systems, while it was possible, for example, to use a register or a point card for discounts or exchanges at a brick-and-mortar store, using the point system, in this case, the point system could only be used at a brick-and-mortar store; furthermore, points were assigned for total cumulative product purchases and points were not specified for detailed assignment to individual products.

Furthermore, it is possible to perform discounts or product exchanges using a point system that, for example, makes use of a user database or the like as part of the online shopping which is developing on the Web; but while it is possible to establish point values to be assigned to individual products in this case, the nature of these systems is such that discounts are actually given simply by assigning points to users who have purchased products, or the like, which has the effect of increasing return business. In the case of this point system as well, the point system can only be used at an online shopping site.

A problem to be solved by the present invention is to provide a system whereby the same point system can be used in a variety of modes, including at brick-and-mortar sales outlets and online sales outlets.

A further problem to be solved is to provide a system whereby points can be specified in detail for individual products or services.

A further problem to be solved is to provide a system that is an improvement on conventional point systems, wherein points were simply assigned and often were not used, by having users who wish to accumulate points in order to use them take an active part, so that points can be made use of effectively and so that user information can be collected by way of active user registration.

A further problem to be solved is to provide a system wherein the serial number used to specify points can be developed in a variety of modes, and wherein by assigning serial numbers to products or the like, the point system of the present invention can be used in commercial transactions of any sort.

A further problem to be solved is to provide a system whereby the user can use accumulated points for shopping.

In order to solve the problems described above, the present invention uses serial numbers that are assigned to individual products, services or the like and performs processing which adds points corresponding to this product, service or the like to the point information in a user information database, making point shopping possible.

### SUMMARY OF THE INVENTION

In order to solve the problems described above, the invention is a server system connectable to a computer network, of which the Internet is representative, and accessed by way of a user terminal for connecting to the computer network, being a point server system using serial numbers characterized in that:

The server system comprises a user information database for storing user information, including personal information for a user and point information, and a point information database for storing point information specified for individual products or services; a serial number that is input and sent, using serial number input means provided in the user terminal for inputting serial numbers assigned to individual products, services, or the like, is received, and user authentication processing and serial number analysis processing are performed; the point information database is referenced and, based on analysis of the serial number, the points corresponding to the product, service or the like in question are determined, and processing is performed to add the determined number of points to the point information in the user information database, so as to make point shopping possible. In a preferred embodiment, the point server system is incorporated into an electronic transaction system.

In another preferred embodiment, the serial number input means are barcode reader means. Alternatively, the serial number input means are digital data reading means for reading embedded information incorporated in digital data. In other embodiments, the serial number input means are image input means or voice input means.

### BRIEF DESCRIPTION OF THE DRAWINGS

FIG. 1 is a system structure diagram showing the basic system structure of the present invention.

FIG. 2 is a drawing showing one example of data stored in a point information database 3.

FIG. 3 is a screen transition diagram showing one example of screens when the point server system of the present invention is accessed from a user terminal and basic processing is performed.

FIG. 4 is a screen transition diagram showing one example of screens when the point server system of the present invention is accessed from a user terminal and basic processing is performed.

FIG. 5 is a screen transition diagram showing one example of screens when the point server system of the present invention is accessed from a user terminal and basic processing is performed.

FIG. 6 is a flowchart illustrating the basic flow when point addition processing and other processing is performed using various forms of user terminals and serial number input means connected to the user terminal.

FIG. 7 is a flowchart illustrating the basic flow when point addition processing and other processing is performed using various forms of user terminals and serial number input means connected to the user terminal.

FIG. 8 is a flowchart illustrating the basic flow when point addition processing and other processing is performed using various forms of user terminals and serial number input means connected to the user terminal.

FIG. 9 is a flowchart illustrating the basic flow when point addition processing and other processing is performed using various forms of user terminals and serial number input means connected to the user terminal.

FIG. 10 is a flowchart illustrating the basic flow when point addition processing and other processing is performed using various forms of user terminals and serial number input means connected to the user terminal.

FIG. 11 is a flowchart illustrating the basic flow when point addition processing and other processing is performed using various forms of user terminals and serial number input means connected to the user terminal.

FIG. 12 is a flowchart illustrating the basic flow when point addition processing and other processing is performed using various forms of user terminals and serial number input means connected to the user terminal.

FIG. 13 is a flowchart illustrating the basic flow when point addition processing and other processing is performed using various forms of user terminals and serial number input means connected to the user terminal.

FIG. 14 is a flow chart illustrating processing details for point addition processing when a serial number is input using various serial number input means, transmitted and analyzed by a point server system.

FIG. 15 is a flow chart illustrating processing details for point addition processing when a serial number is input using various serial number input means, transmitted and analyzed by the point server system.

FIG. 16 is a flow chart illustrating processing details for point addition processing when a serial number is input using various serial number input means, transmitted and analyzed by the point server system.

FIG. 17 is a flow chart illustrating processing details for point addition processing when a serial number is input using various serial number input means, transmitted and analyzed by the point server system.

FIG. 18 is a flow chart illustrating processing details for point addition processing when a serial number is input using various serial number input means, transmitted and analyzed by the point server system.

FIG. 19 is a flow chart illustrating processing details for point addition processing when a serial number is input using various serial number input means, transmitted and analyzed by the point server system.

FIG. 20 is a flowchart illustrating the flow of requests for exchanges for products or the like, and point subtraction processing.

FIG. 21 is a flowchart illustrating the flow for questionnaire processing.

FIG. 22 is a flowchart illustrating the flow for authentication processing using authentication information such as a member ID and a password.

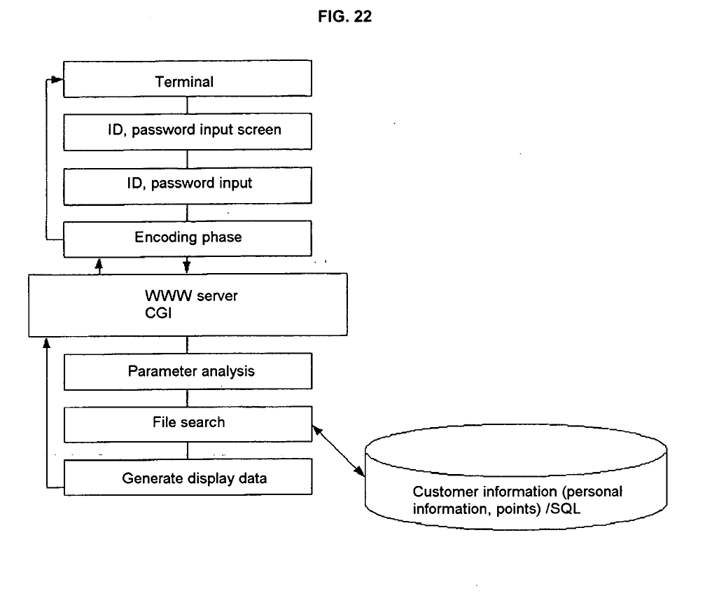

FIG. 23 is a flowchart illustrating the flow for authentication processing wherein authentication information is stored on a data storage medium such as an IC card and this authentication information is transmitted.

FIG. 24 is a flowchart illustrating the flow for processing serving to display input screens.

FIG. 25 is a flowchart illustrating the flow for encryption processing.

FIG. 26 is a flow chart illustrating the flow for paging processing so as to make known, for example, event information such as information on new products and information on sales at a point-shopping web site.

### DETAILED DESCRIPTION OF THE INVENTION

Hereinafter, modes of embodiment of the present invention are described in detail by way of the drawings.

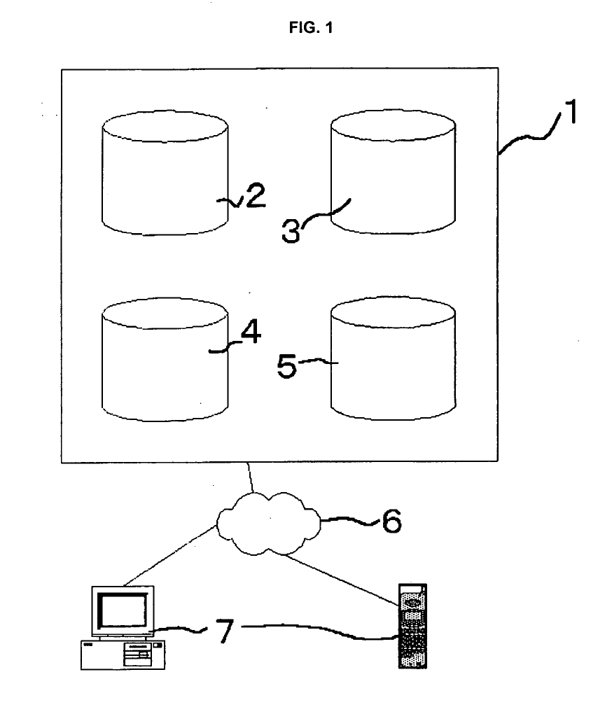

FIG. 1 is a system structure diagram showing the basic system structure of the present invention.

In FIG. 1, reference numeral 1 indicates a point server system; 2 indicates a user information database; 3 indicates a point information database; 4 indicates a web server; and 5 indicates an application server. Furthermore, 6 indicates a computer network and 7 indicates a user terminal.

The system of the present invention is connectable to a computer network 6, of which the Internet is representative, and is a server system accessed by way of the user terminal 7, which is connected to the computer network.

This computer network 6 can take a wide variety of forms including, not only the Internet, but also network configurations connected to by means of a dedicated line, intracompany local area networks (LANs), intercompany LANs and wide area networks (WANs).

Furthermore, the communication circuits used to this effect include various configurations such as landline communication and various types of wireless communication, including satellite communication and Bluetooth.

Next, computer terminals such as personal computers and workstations are normally used as the user terminal 7 for connecting to the server system of the present invention.

A computer terminal comprises control means, storage means, input means, output means, display means, and the like. Furthermore, in common modes, in conjunction with the computer network of which the Internet is representative, data transmission and reception functions are provided; and software for browsers and electronic mail, application programs such as word processors, and an operating system (OS) are provided.

In addition, the user terminal 3 broadly encompasses devices such as wireless communication terminals of which portable telephones having browser functions allowing for connection to the Internet or the like are representative, PDAs, Internet TV, game consoles, video conferencing systems and other household appliances that can be connected to networks.

Next, the server system of the present invention normally comprises an application server, a database server, an authentication server, a web server, other e-mail servers as necessary, and various other devices.

In terms of these various servers, modes wherein these are provided in a single physical device, modes comprising a plurality of physical devices and modes comprising a plurality of physical devices connected by way of a network are included; a variety of modes are included, so long as functionally equivalent functions are performed.

The server system of the present invention comprises storage means, control means, input means, output means, display means, and the like.

The server system has a CPU, RAM, ROM, system control means and the like, and comprises reception means for receiving data from a client computer, transmission and means for transmitting data to the client computer, storage means such as a hard disk, display means such as a CRT when necessary, and input means such as a keyboard.

The server system comprises a user information database 2 for storing user information, including personal information for the user and point information, and a point information database 3 for storing point information specified for individual products or services.

The information stored in the user information database 2 includes a member ID for users registered as members, authentication information such as a password for authentication, personal information such as a name and an e-mail address, and a current number of points.

The information stored in the point information database 3 includes a number of points specified for each product and a number of points specified for each service; this information is used to determine the number of points to be attributed to a user when a user inputs and sends a serial number by way of serial number input means, by referencing the point information database 3. Accordingly, a serial number and a number of points specified for a product or the like corresponding thereto are stored in association with each other.

Note that the number of points specified is normally specified as identical for an identical product; processing is such that, for example, if a personal computer A is purchased, this is determined to be 500 points based on the serial number; furthermore, if a digital camera B is purchased, this is determined to be 100 points based on the serial number; furthermore, if a digital camera C is purchased, this is determined to be 80 points based on the serial number; and the points are added to the current number of points in the user information database.

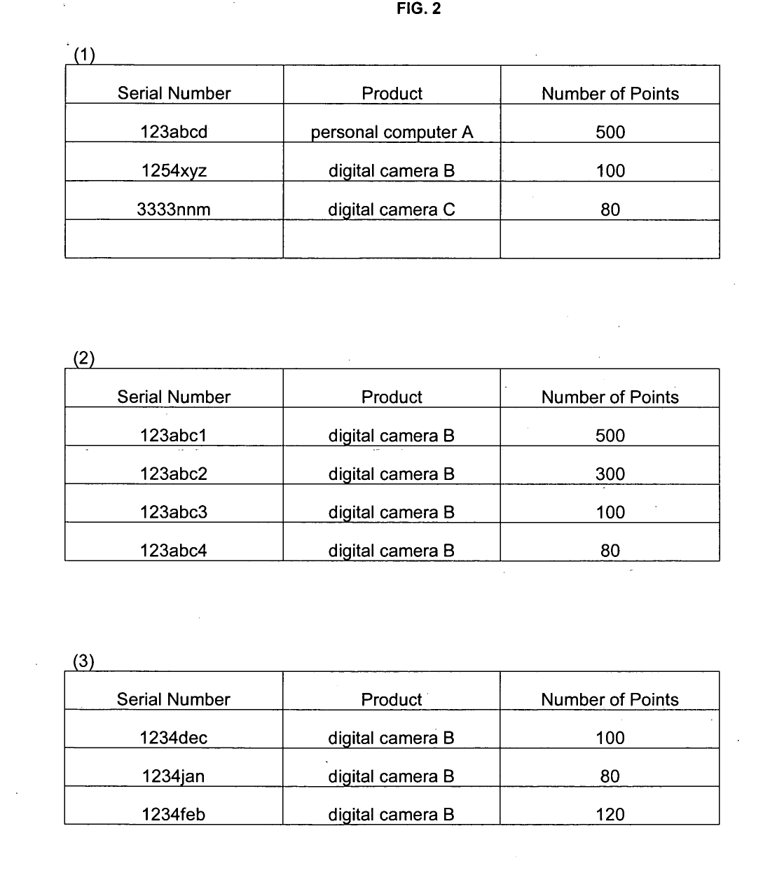

FIG. 2 shows one example of data stored in the point information database 3; FIG. 2 (1) shows the point information specified for each product.

Meanwhile, in a variant embodiment, a plurality of numbers of points are specified in the point information database 3 for an identical product and, by way of processing wherein, if person a purchases a digital camera B, this is determined to be 100 based on the serial number, and if a person b purchases the same digital camera B, this is determined to be 80 points based on the serial number, and the points are added to the current number of points in the user information database 2; thus an embodiment is possible similar to lottery-based reductions for purchasers. For example, this is specified so that a first prize is 300 points, a second prize is 200 points, a third prize is 100 points, and in all other cases this is 80 points.

FIG. 2 (2) shows one example of point information in this case.

In a further variant embodiment, a plurality of numbers of points are specified in the point information database 3 for an identical product depending on a time period or other criterion, so that an embodiment is possible wherein a reduction is made corresponding to a sale period or the like, by means of processing wherein, for example if the digital camera B is purchased in December, this is determined to be 100 based on the serial number and, if the same digital camera B is purchased in January, this is determined to be 80 based on the serial number, and the points are added to the current number of points in the user information database 2.

FIG. 2 (3) shows one example of point information in this case.

Furthermore, it is possible to establish the number of points to be added according to whether the product or the like was purchased in a brick-and-mortar store or whether this was purchased by online shopping, or according to the type of serial number input means used to input to the serial number.

Next, in the present invention, a user terminal 7 is provided; using serial number input means for inputting serial numbers assigned to individual products, services or the like, the serial number is input and sent to the point server system, and user authentication processing and serial number analysis processing are performed.

Accordingly, the user terminal 7 is provided with serial number input means for inputting serial numbers and authentication information input means for inputting user authentication information; in one example of a commonly used mode, an entry form or the like, for the purpose of inputting serial numbers and authentication information is displayed on the Web so that, in this embodiment, input is performed by a keyboard, or the like, provided in the user terminal 7.

Furthermore, as described below, various modes are possible for the serial number input means, such as barcode reading means, digital data reading means, image input means, voice input means, and the like.

Furthermore, in addition to input means such as keyboards, it is possible to use other authentication means, such as authentication information stored in a hardware key such as an IC card, various types of memory, a USB key, or the like, as well as fingerprint recognition, voice-recognition or the like.

Furthermore, a serial number can be incorporated into the product itself as data, so that this can be read; in this case, the serial number input means are digital data reading means. For example, this is the case when a serial number is incorporated into software, digital contents or the like, as digital data; in such a case, the mode is one wherein an information storage medium in which the digital data is stored is provided in the user terminal, and this is read. The information storage medium is provided in the personal computer used as the user terminal 7, or in any one of various types of information storage media connected thereto, such as a CD-ROM drive, a floppy disk drive, and ID card reader, a memory slot, or another information storage medium which can be read by digital data reading means supporting this.

Furthermore, in cases where a portable telephone is used as the user terminal 7, the serial number can likewise be read from various types of information storage media; moreover the personal information and authentication information for the user may be stored in an information storage medium provided in a user terminal 7 such as a portable telephone, and this may be used.

One example of an information storage medium is a removable hard-drive memory or the like; with the IMT2000 w-CDMA system, a memory card is loaded with authentication information such as a user ID, an expansion application, a telephone book, and the like. These devices use credit card or chip sized nonvolatile memory and therefore allow for user migration, which is to say, number portability. Consequently, if the user buys a new terminal or rents a terminal having a slightly different standard in a foreign country, these can be used immediately, simply by slotting in the card. With conventional systems, it was necessary to visit the store each time a replacement terminal was purchased, or the terminal had to be taken in so as to apply for a number transfer or the like; but cards allows these inconveniences to be overcome.

The various modes for serial number input means include, for example, such terminal input means as personal computer terminal input means, portable barcode terminal input means, POS registers, PDA input means, game terminal input means, infrared terminals, public telephone terminals, IC card terminals, telephones, and the like.

In one embodiment, the serial number input means are barcode reader means. In another embodiment, the serial number input means are digital data reading means for reading embedded information incorporated in digital data. In yet another embodiment, the serial number input means are image input means. In another embodiment, the serial number input means are voice input means.

In terms of modes for the serial number, the mode may be such that the serial number is written on the product, on the packaging or wrapping of the product, or on labels, instructions, guarantees, or the like included with the product, or the mode may be such that printed matter or the like on which the serial number is written is distributed when the product or the like is purchased.

In this case, the serial number is input using serial number input means such as a keyboard provided on the user terminal 7. Furthermore, in terms of another mode for the serial number, the mode may be such that a printed barcode is provided on the product, on the packaging or wrapping of the product, or on labels, instructions, guarantees or the like, included with the product, or the mode may be such that printed matter or the like on which a printed barcode is provided is distributed when the product or the like is purchased. In this case, the serial number is input using serial number input means such as a barcode reading means provided on the user terminal 7.

Furthermore, as another mode for the serial number, the mode may be such that digital data is incorporated into the product itself, or the mode may be such that an information recording medium (for example, an IC card, memory, or the like) in which digital data is stored, is distributed when the product or the like is purchased.

In this case, the serial number is input using serial number input means such as a digital data reading means provided on the user terminal 7.

For example, if the IC card is used as the information storage medium that stores the serial number, security can be enhanced as compared with such currently commonly used magnetic cards as cash cards, telephone cards and the like, and information capacity can be greatly increased, which makes IC cards highly viable for personal authentication for EC, which is expected to be developed in the future, and as a tool for electronic money.

Furthermore, in terms of the IC card, in addition to a contact type IC card, non-contact type IC cards can be used: as non-contact type IC cards do not have terminals, they all are resistant to soiling and static electricity and the like, and can transfer information over communication distances of several millimeters to several meters; research is, therefore, under way into actualization in the new fields of electronic tickets and product flow tags and the like, as well as transfers from current magnetic cards and contact type IC cards.

Reading is performed simply by passing the IC card nearby, and data is downloaded at high speed.

Furthermore, in like manner, in terms of the information storage medium that stores the serial number, various types of information storage media of the type which do not make contact with the user terminal can be used, and data can be sent and received by communication carriers between the medium and the user terminal such as radio communication, Bluetooth, infrared communication and the like.

Furthermore, as another mode for the serial number, the mode may be such that digital data is incorporated into the product itself, so that this can be used as embedded information in the digital data; an example of such a mode is an electronic watermark wherein specific information is embedded in multimedia data, such as images, video or audio, in such a way as to have almost no influence on the picture quality or sound quality. Data wherein “watermark” data is embedded in an image looks, superficially, no different from the original data, but when read with special electronic watermark detection software, embedded information concerning the creator and the number times it has been copied is revealed. Consequently, while embedding the serial number data, it is possible to prevent illegal copying and falsification.

Electronic watermarks can be incorporated in so-called multimedia content such as static images, video, audio, text data, printed material, and the like.

For example, with image data, the picture elements are divided into a plurality of blocks and bit information indicating brightness is directly processed so as to embed the watermark. The system makes use of characteristics whereby people cannot readily recognize dark pixels close to light pixels. These methods have the advantage of requiring little processing time.

Alternatively, methods may be employed wherein image data is converted into frequency components by such representative means as Fourier transformation (FE-r), spectral diffusion, discrete cosine transform (DCT) and the like, and watermark information is embedded in specific frequency components in such a way as to avoid influencing image quality.

Furthermore, one mode for serial numbers is to embed an electronic watermark in video data. With the development of media such as DVD, the importance of electronic watermarks for video is increasing. In terms of electronic watermarks for video, if one considers that video images are a collection of static images, watermark technology for static images can, in principle, be used.

Furthermore, one mode for serial numbers is to embed an electronic watermark in audio data. It goes without saying that audio cannot be seen with the eye, so watermark information is embedded at audio frequencies that cannot be heard by the human ear. Methods include those wherein, as with static images, this is embedded in frequency components, such as by spectral diffusion, or methods known as echo control, wherein and echo which cannot be heard by the human ear is produced and a watermark signal is included therein.

Moreover, as one mode for serial numbers, methods wherein an electronic watermark is embedded in text data include techniques using spacing or techniques wherein a code is embedded, which does not have any effect whatsoever on the sentences themselves.

Furthermore, as one mode for serial numbers, methods wherein an electronic watermark is embedded in printed matter include techniques wherein, at the time of printing, the letters are slightly rotated or vertically shifted, or the spacing is changed, or wherein optical processing is performed on the printing paper.

Hereinafter, the basic processing flow of one mode of embodiment of the point server system 1 of the present invention is described. Note that the processing flow disclosed herein illustrates one example of an exemplary mode, and the invention is not limited thereto.

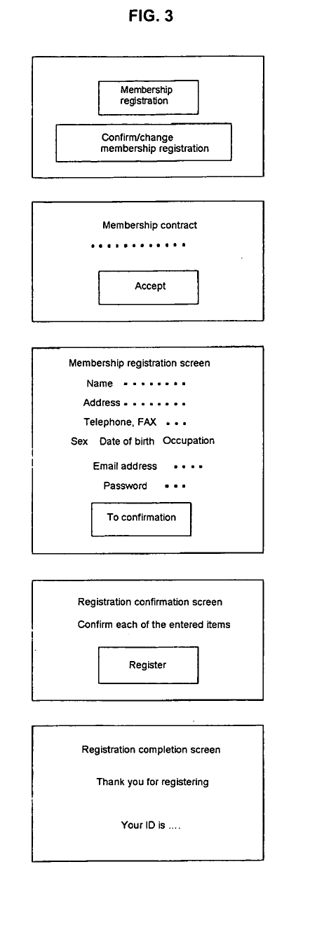

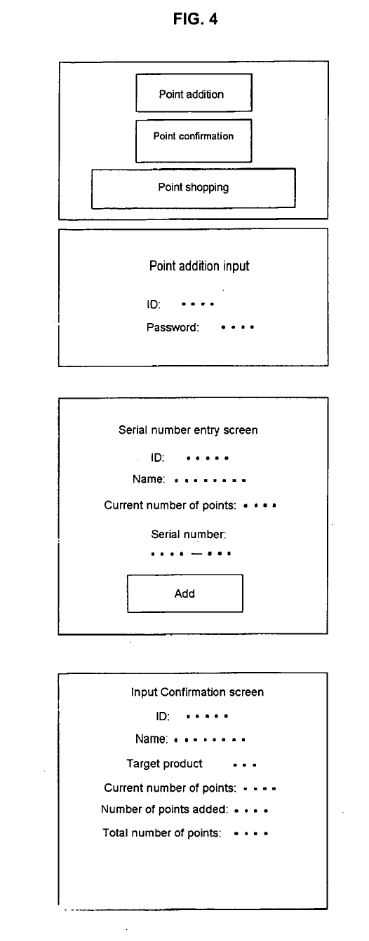

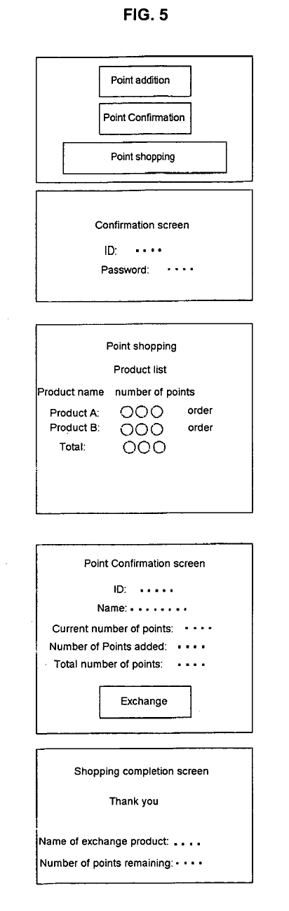

FIG. 3, FIG. 4, and FIG. 5 show one example of screens when the point server system of the present invention is accessed from a user terminal and basic processing is performed.

First, as a prerequisite for using the system of the present invention, the user registers as a member by way of the user terminal 7.

FIG. 3 shows the processing in this case; the point server system 1 of the present invention is accessed from a user terminal 7, such as a personal computer or a portable telephone, by connecting to a computer network 6, of which the Internet is representative.

A member registration menu is selected and a registration screen is displayed on a web page.

Activities such as checking membership terms, an explanation of the system and the like are performed, whereafter an entry form for membership registration is displayed.

The user enters such personal user information as a name, an address, a telephone number, a fax number, a sex, a date of birth, a profession, an e-mail address and the like. Furthermore, a password is entered.

After input, the information that has been input is checked and corrected where correction is necessary, whereafter one continues.

Next, after checking, by pressing a “register” button or the like, the information that has been input is sent, and is received by the point server system 1; the information that is received is stored in the user information database 2.

Next, a generated member ID is added to and stored with the user information that is stored in the user information database 2 and, in order to respond to the user who has registered as a member with their member ID, an e-mail message is created for the e-mail address that has been registered, and the user is notified of their membership ID by sending this to the user terminal 7. Alternatively, the membership ID is made known by creating a file that can be displayed on the Web such as an HTML file or a CHTML file, setting forth information including the member ID, and this is sent to the user terminal 7.

In this manner, member registration is completed.

Furthermore, it is desirable that, if there is a change in the registered user information, or when the password is changed or the like, the member user accesses the system and uses their member ID and password to make these changes.

Next, the processing flow when a serial number is entered and transmitted and points are added, using the system of the present invention, will be described.

FIG. 4 shows the processing in this case; first, the point server system 1 of the present invention is accessed from a user terminal 7, such as a personal computer or a portable telephone, by connecting to a computer network 6, of which the Internet is representative.

Note that, as a prerequisite for entering the serial number, the user must obtain a serial number in one of the various modes described above, by purchasing a product or the like, and use this serial number for entry. Furthermore, when a plurality of products are purchased, a plurality of serial numbers are input and sent in succession.

The point server system is accessed and the point addition menu is selected.

Next, authentication information for the purpose of personal authentication of the member, specifically a user ID and a password, are entered.

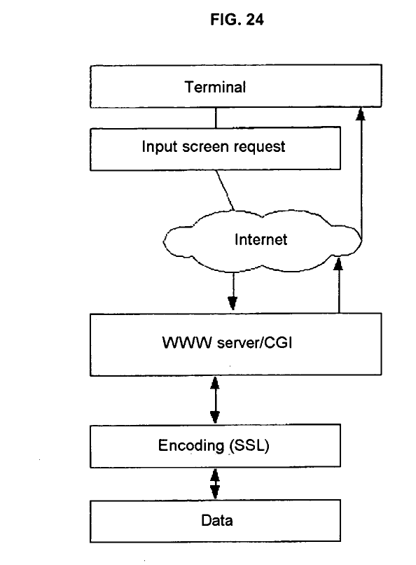

The processing flow for displaying the input screen is shown in FIG. 24. The flow for authentication processing using authentication information such as a member ID and a password is shown in FIG. 24.

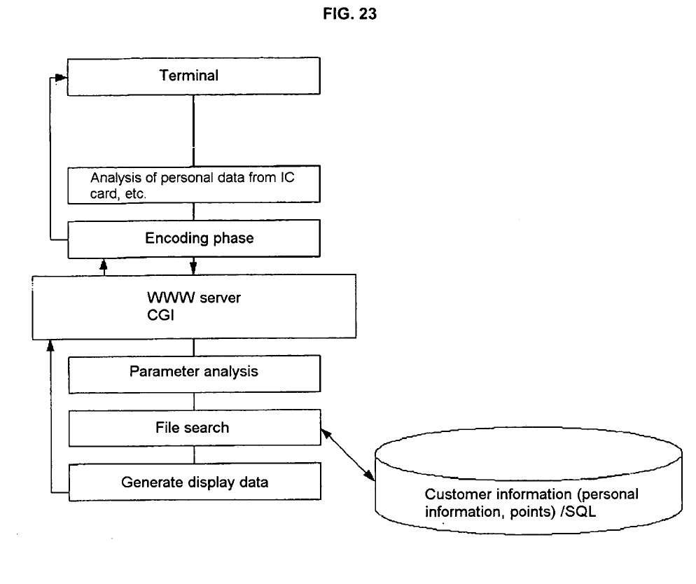

FIG. 23 shows the flow for authorization processing wherein authorization information is stored on a data storage medium such as an IC card and this authorization information is transmitted.

Next, as one example of a preferred mode, as shown in FIG. 4, as a result of sending the authentication information, the point server system 1 references the user information database based on the authentication information received; data such as the user information and information on current points is extracted for the corresponding member ID, and input means for inputting the serial number assigned to individual products, services or the like from the user terminal, specifically an entry form or the like, is created as a file which can be displayed on the Web. This is sent to the user terminal and displayed.

Next, at the user terminal 7, the displayed information is verified and, using the entry form described above, the serial number is input and sent to the point server system 1.

This is a mode wherein input is performed using serial number input means such as a keyboard but, as described above, various modes are possible for the serial number and the serial number input means.

User terminals provided with serial number input means include a variety of devices, such as various terminals provided with barcode reading means, POS register terminals, and terminals provided with IC card readers; in terms of the method of entering the serial number, in addition to methods wherein this is entered manually using a keyboard or the like, barcode reading, reading of embedded information, voice input, scanner input, and image input from digital cameras and digital video cameras are possible.

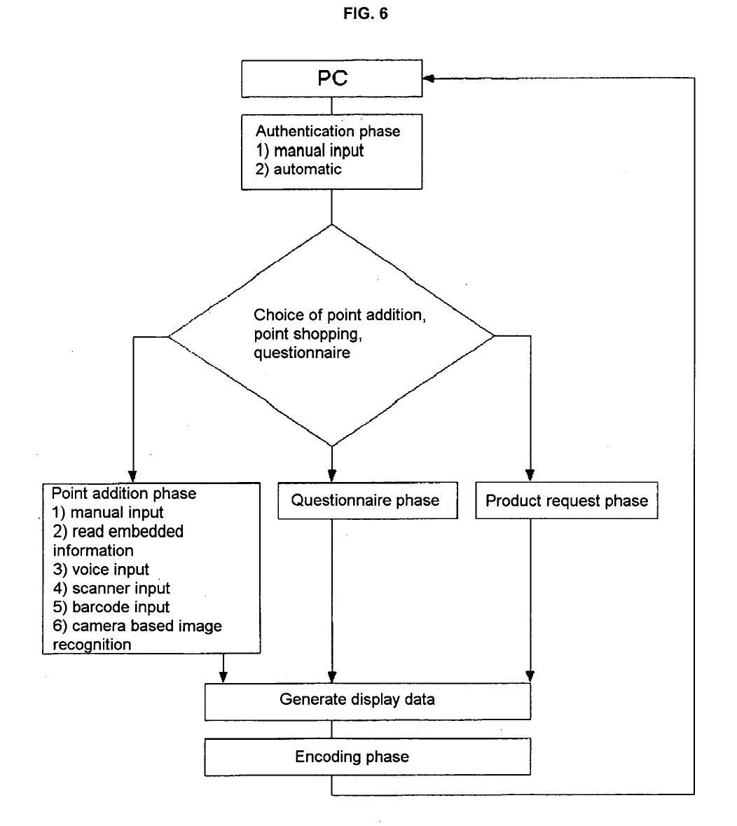

Here, FIG. 6 to FIG. 13 are flow charts showing the basic flow for point addition processing and other types of processing using a personal computer (PC) and various other modes of user terminals 7 and serial number input means connected to the user terminal 7. Note that other processing is described below.

FIG. 6 shows a mode wherein a personal computer is used as the user terminal 7.

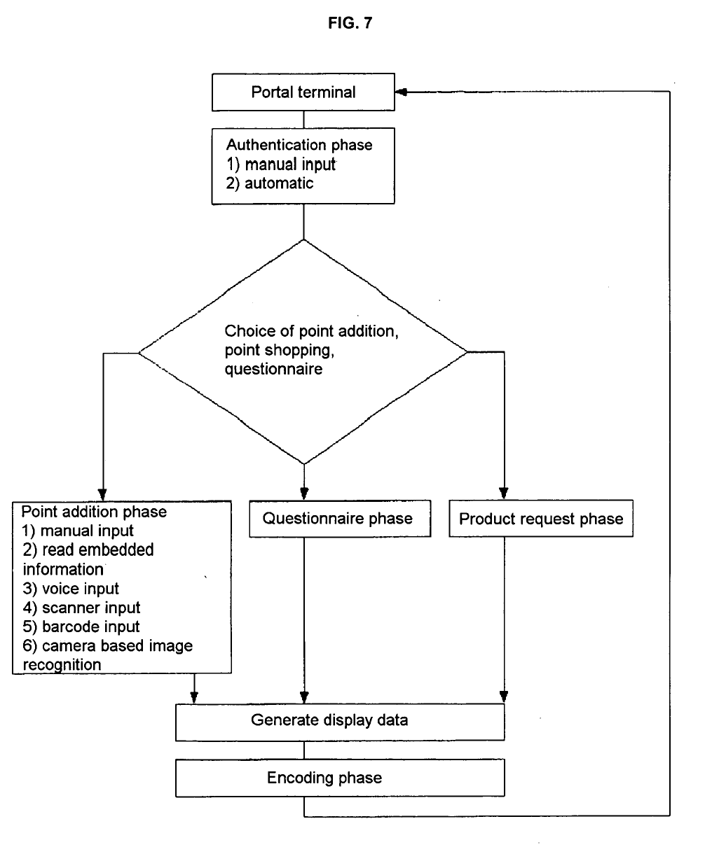

FIG. 7 shows a mode wherein a portable information terminal, such as a portable telephone, is used as the user terminal 7.

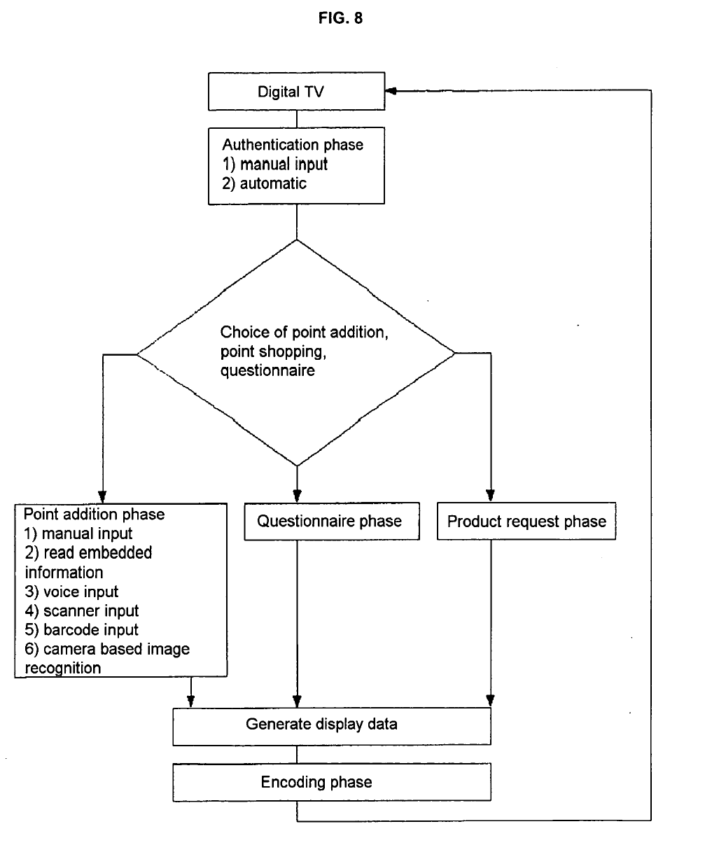

FIG. 8 shows a mode wherein a digital TV is used as the user terminal 7.

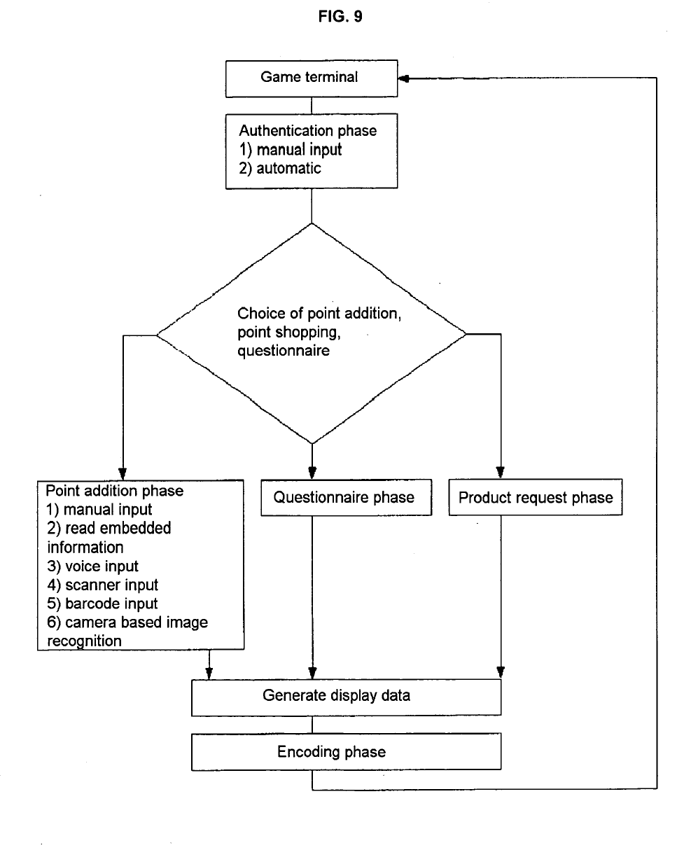

FIG. 9 shows a mode wherein a game console terminal is used as the user terminal 7.

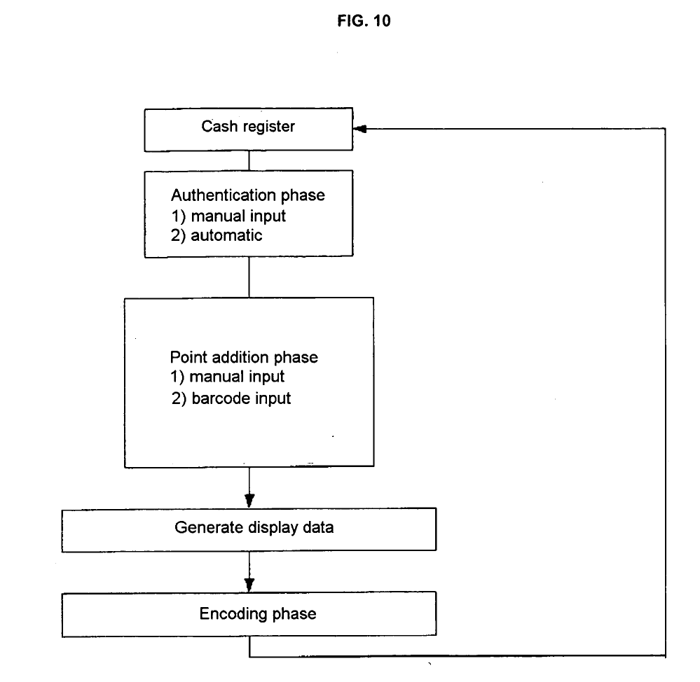

FIG. 10 shows a mode wherein a POS register terminal is used as the user terminal 7.

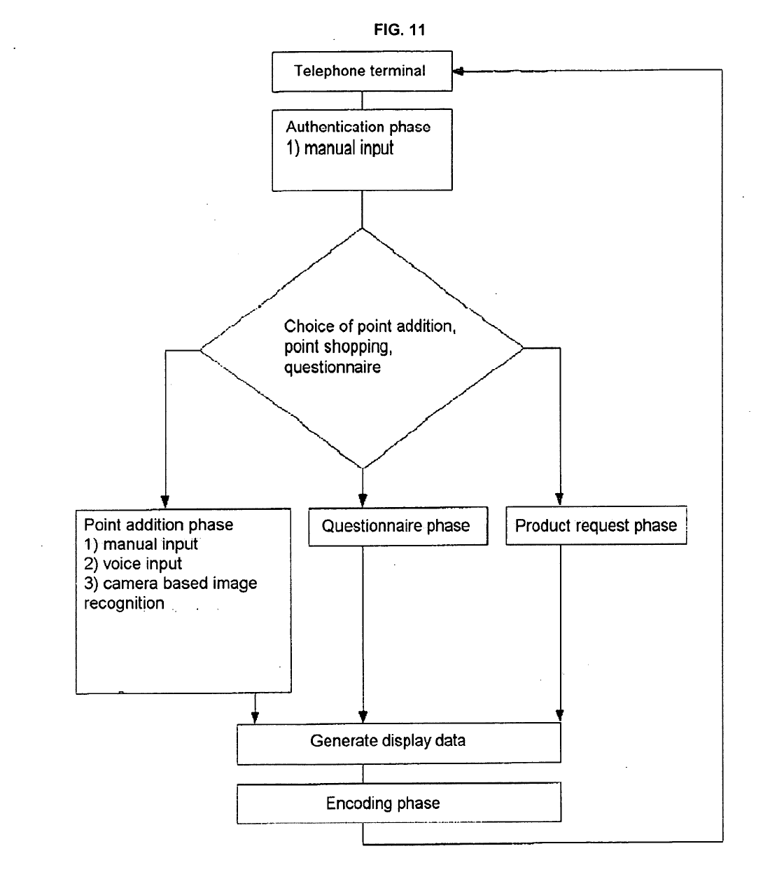

FIG. 11 shows a mode wherein a telephone terminal is used as the user terminal 7.

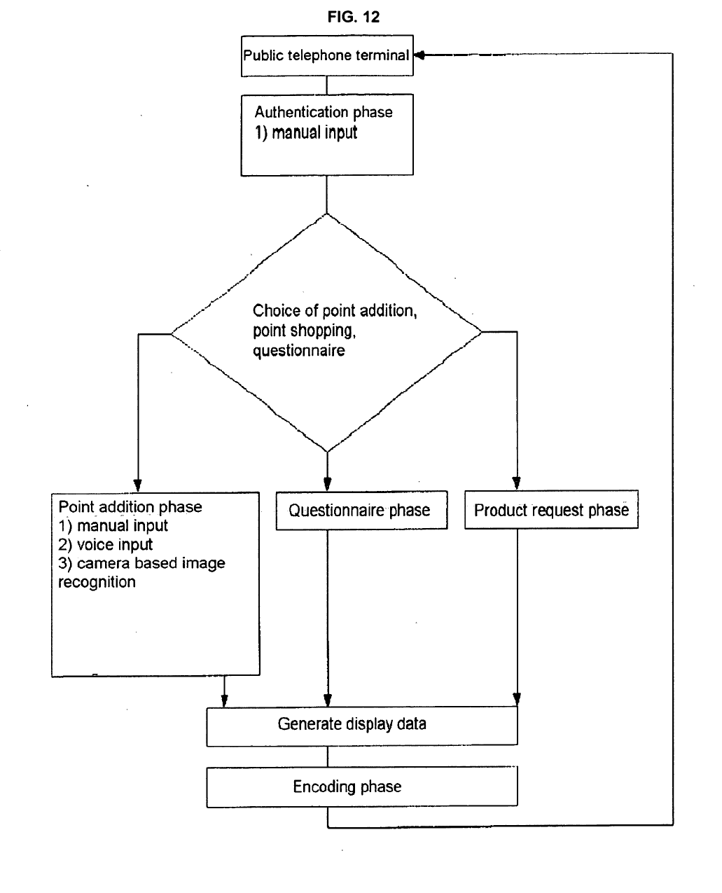

FIG. 12 shows a mode wherein a public telephone terminal is used as the user terminal 7.

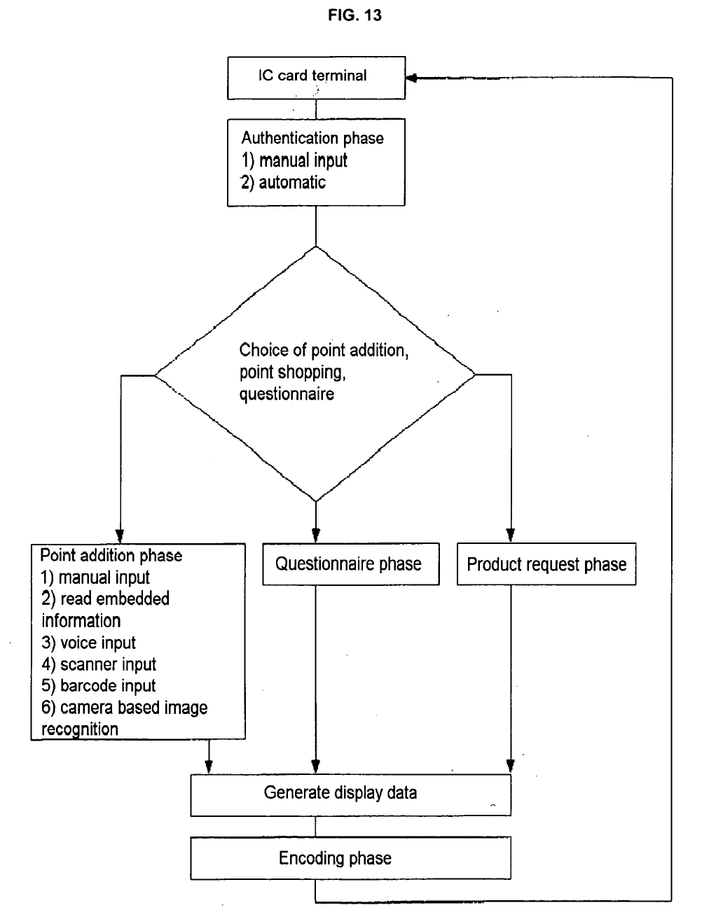

FIG. 13 shows a mode wherein an IC card terminal is used as the user terminal 7.

Next, the serial number which has been input is sent and the point information database 3 is referenced by the point server system, based on the serial number information received; data for the corresponding product or the like referenced based on the serial number; the corresponding point information is extracted; and data including the current point information and the point information to be added thereto are generated in the form of a file to be displayed on the Web. These are sent to the user terminal and displayed. The display items include the member ID, the name, the name of the target product corresponding to the serial number, current point information, information on the points to be added, and information on cumulative points after addition or the like.

In cases where a plurality of serial numbers are input, this processing is repeated.

Furthermore, the point information after addition is successively used to update the current point information stored in the user information database, and this is stored. By these means, addition of the points corresponding to the product or service in question to point information in the user information database is completed.

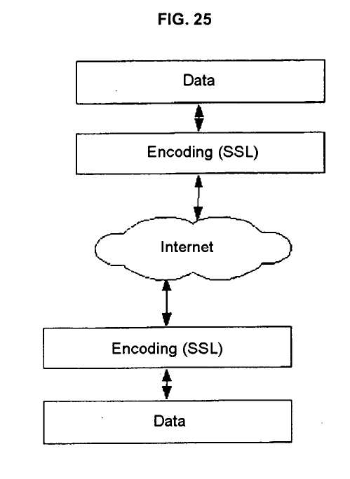

Note that, in addition to the processing described above, when the serial number which has been input and sent by the user terminal is received by the point service system 1, serial number encryption processing, and encryption processing in the point server system 1 can be added and the processing in which user authentication processing and serial number analysis processing are performed. The processing flow for encryption processing is shown in FIG. 25.

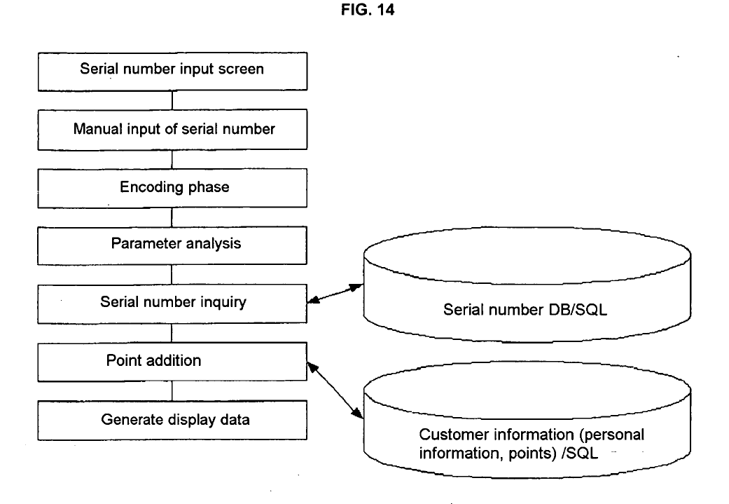

FIG. 14 to FIG. 19 are flow charts illustrating processing details for point addition processing when a serial number is input using various serial number input means, transmitted and analyzed by the point server system 1.

FIG. 14 shows an input process based on operations that use input means such as a keyboard for the serial number input means.

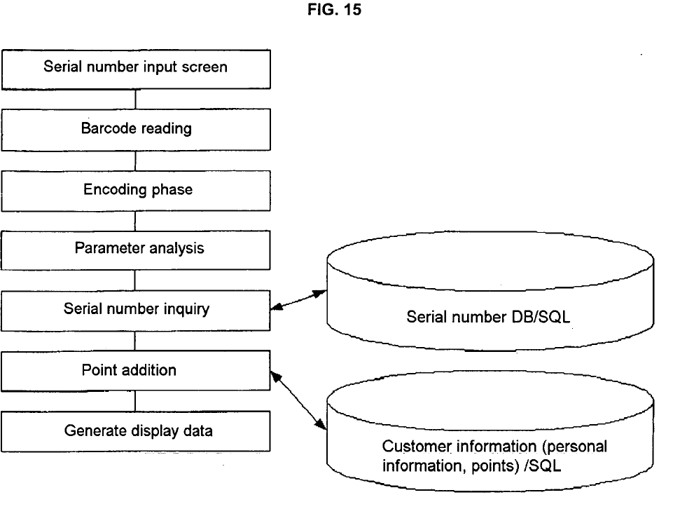

FIG. 15 shows processing using a barcode reader means for the serial number input means.

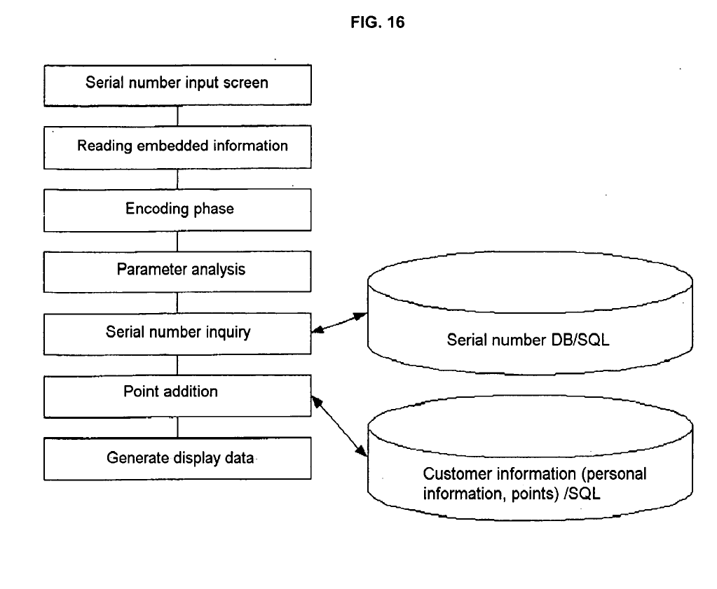

FIG. 16 shows processing using an embedded information reader means for the serial number input means.

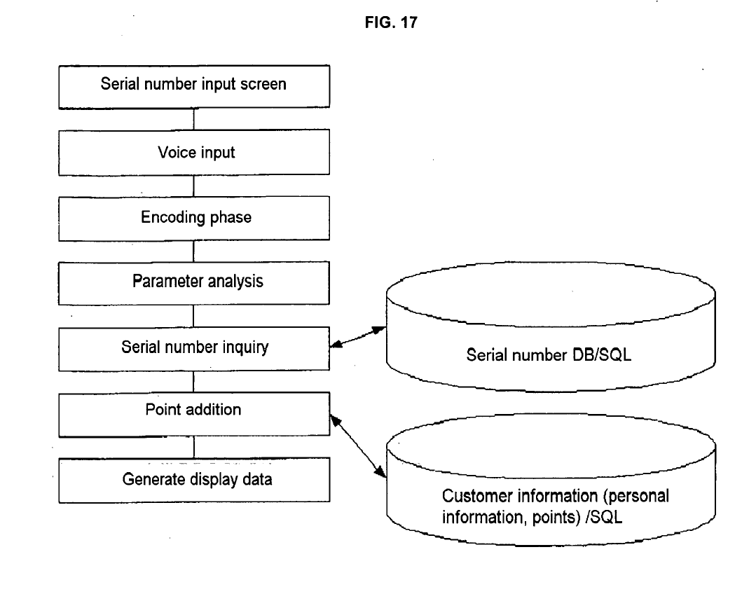

FIG. 17 shows processing using voice input means as the serial number input means.

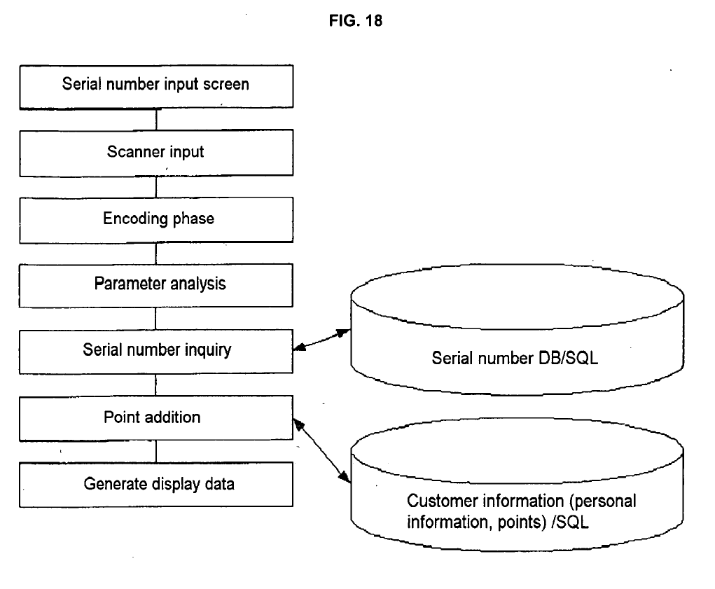

FIG. 18 shows processing using a scanner-based image input means as the serial number input means.

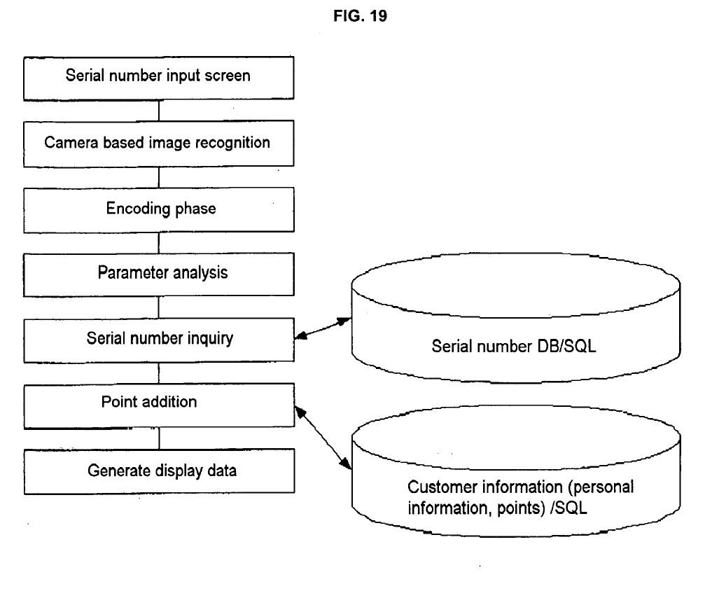

FIG. 19 shows processing using a camera-based image input means as the serial number input means.

By means of the processing described above, the points stored as the current point information in the user information database can be used in the same manner as money for shopping at shopping sites that provide the point server system of the present invention and shopping sites established with a connection to a computer network associated with the point server system of the present invention, so as to allow point shopping.

Note that, as another mode of embodiment of the point addition processing described above, user information may be collected by soliciting responses to a questionnaire, in parallel with the point addition processing, or following the point addition processing, and having this sent.

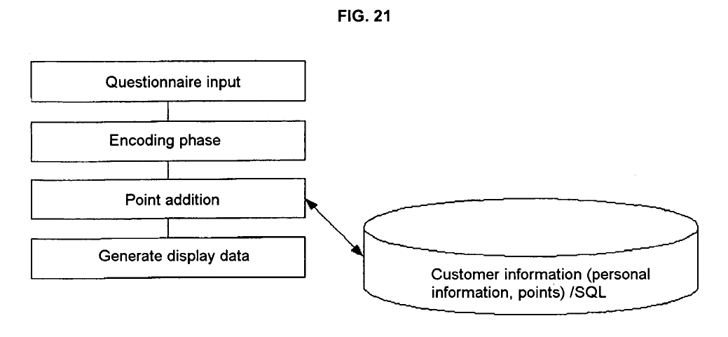

The questionnaire processing flow is shown in FIG. 21.

In this case, a mode is possible wherein, when answers are provided to the questionnaire or the like, a premium is applied to the points added.

Methods of assigning a premium to points include methods wherein the number points to be added when a reply is provided to a questionnaire or the like, and the number of points to be added when a reply is not provided, are stored beforehand in the point information database as shown in FIG. 2. For example, this information is such that, if a user having bought a digital camera C replies to the questionnaire or the like, the number of points added will be 100, and if a reply is not provided the number of points added will be 80.

Furthermore, another method is a mode wherein a value by which the points will be multiplied if a reply is provided is specified and stored and, if a reply is provided to the questionnaire or the like, the points to be added are multiplied by a predetermined value (for example 1.2).

For example, this mode may be such that, a user having bought a digital camera D has 100 points added, but the point server system determines whether or not a reply has been given to the questionnaire or the like and, if a reply has been given, this is multiplied by a predetermined value (for example, 1.2) so that 120 points are added; and if a reply is not given, the unchanged value of 100 points is added.

Next, using FIG. 5 processing for point shopping, using the current user point information stored in the user information database 2, is described.

First, the point server system 1 is accessed by connecting to a computer network 6, of which the Internet is representative, from the user terminal 7.

The user selects the point shopping menu, the member ID and password are entered and sent from the user terminal 7 and authentication processing is performed; whereby the point server system 1 receives authentication information, references the user information database 2, and extracts the member user information in question.

Next a file for display on the Web such as an HTML file or a CHTML file including the extracted user information is created, sent to the user terminal 7 and displayed.

The displayed information includes, for example, the current points, a list of the products and services which can be purchased (exchanged for points) using the current points, the number of points required and the like.

Note that information relating to the number of points required for an exchange for an individual product or an individual service is stored beforehand, as required point data, in the point information database 3, in the same manner as shown in FIG. 2.

Accordingly, in creating the file to be displayed on the user terminal as described above, data is extracted from the information stored in the point information database 3 and set forth in the file.

If the user wants one of the items in the displayed list of products and services, the user selects the desired product or the like with the user terminal and sends this together with authentication information (member ID, password and the like), which is received by the point server system 1.

The point server system 1 references the corresponding user information database 2 and, based on the information received, references the current point balance, and compares it with the points required for an exchange for (purchase of) the desired product or the like so as to verify a sufficient balance. If the balance is insufficient, a file indicating the same is returned and displayed.

If the balance is sufficient, a confirmation screen file is returned to the user terminal 7 and displayed. One example of the contents of the confirmation screen is that including, as shown in FIG. 5, the member ID, the name, the current number of points, the necessary number of target points for the product or the like that is the object of the exchange, and the number of points remaining after these have been used.

After confirmation, “exchange” is selected on the user terminal 7, and when that information is received by the point server system 1, the exchange request information from the user terminal is associated with the user information in the user information database 2 and stored in the user information database 2. Specifically, the information includes the name of the exchange product, the shipping address and the like. Furthermore, the predetermined number of points which were determined to be necessary for an exchange for the product or the like are subtracted from the current point information and the current point information is updated and stored.

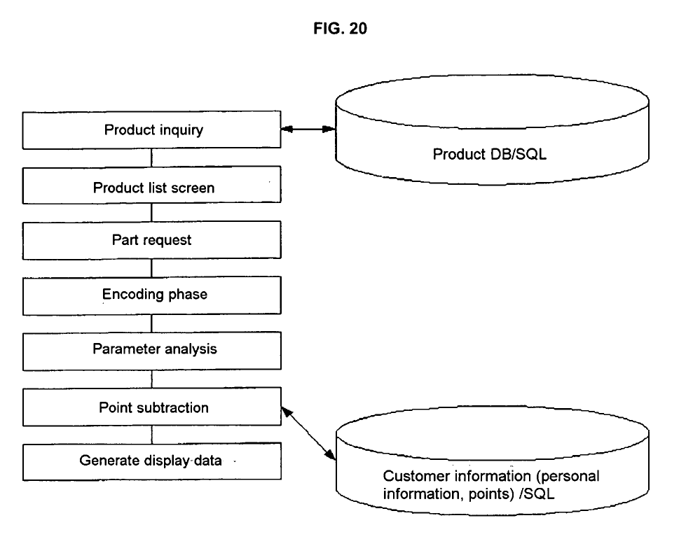

The flow of requests for exchanges for products or the like and point subtraction processing is shown in FIG. 20.

Furthermore, a confirmation screen file indicating that the exchange for the product or the like has been completed is created and sent to the user terminal 7, whereby confirmation information such as the name of the product exchanged, the number of points remaining, the shipping address, the shipping date, and the like, are displayed. Note that a mode is also possible wherein the confirmation information is sent by e-mail or the like.

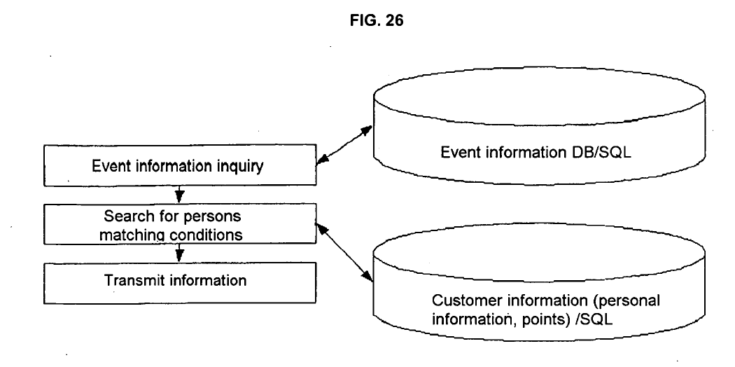

Furthermore, other processing includes, for example, the paging processing shown in FIG. 26. For example, an event information database storing information about a new product, or event information such as information about a sale on a point-shopping web site is provided in the point server system 1.

The point server system 1 matches the attributes of individuals who would be potential targets for the event, such as sex, age, interests, location and the like, from the information stored on the event information database, and personal information such as user attributes, which are stored in the user information database 2. Modes of matching processing are possible wherein this is performed when information for a new event is stored, or periodically at fixed intervals.

As a result of the matching, a determination is made as to whether a matching information pair is present, and the user in the resulting determined match is extracted and event information is sent to that e-mail address.

Consequently, the user is effectively notified of information on new products, sale information and the like.

As described in detail above, by virtue of the present invention, using a serial number applied to individual products, services or the like, processing is performed which adds points, corresponding to this product, service or the like to point information in a user information database, making point shopping possible.

Furthermore, a system can be provided whereby the same point system can be used for a variety of modes, including brick-and-mortar sales outlets and online sales outlets.

Furthermore, a system can be provided whereby points can be specified in detail for individual products or services.

Furthermore, a system can be provided that is an improvement on conventional point systems, wherein points were simply assigned and often were not used, by having users who wish to accumulate points in order to use them take an active part, so that points can be made use of effectively and so that user information can be collected by way of active user registration.

Furthermore, a system can be provided wherein the serial number used to specify points can be developed in a variety of modes, and wherein by assigning serial numbers to products or the like, the point system of the present invention can be used in commercial transactions of any sort.

Furthermore, a system can be provided whereby the user can use accumulated points for shopping.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. (canceled)

2. (canceled)

3. (canceled)

4. (canceled)

5. (canceled)

6. (canceled)

7. A point server system, connectable to a computer network and accessed by way of a user terminal connected to the computer network comprising:
a user information database for storing user information, wherein the user information database comprises a plurality of personal information for a user and a plurality of point information for the user;
a point information database for storing a number of points corresponding to at least one product or service; and
a serial number input means, provided in the user terminal for inputting serial numbers assigned to at least one of the products or services, wherein at least one serial number is input and sent using the serial number input means;
wherein the point information database is used to determine a plurality of points corresponding to the product or service based on the serial number of the product or service, and the determined number of points is added to the point information for the user in the user information database.

8. The point server system of claim 7, wherein the serial number input means is a barcode reader.

9. The point server system of claim 7, wherein the serial number input means is a digital data reading means for reading embedded information incorporated in digital data.

10. The point server system of claim 7, wherein the serial number input means is an image input.

11. The point server system of claim 7, wherein the serial number input means is a voice input.

12. The point server system of claim 7, wherein the computer network is selected from the group consisting of:
a) an Internet;
b) an intracompany local area network;
c) an intercompany local area network; and
d) a wide area network.

13. An electronic business transaction system, comprising:
a point server system, connectable to a computer network and accessed by way of a user terminal connected to the computer network comprising:
a user information database for storing user information, wherein the user information database comprises a plurality of personal information for a user and a plurality of point information for the user;
a point information database for storing a number of points corresponding to at least one product or service; and
a serial number input means, provided in the user terminal for inputting serial numbers assigned to at least one of the products or services, wherein at least one serial number is input and sent using the serial number input means;
wherein the point information database is used to determine a plurality of points corresponding to the product or service based on the serial number of the product or service, and the determined number of points is added to the point information for the user in the user information database.

14. A method of point shopping, comprising the steps of:
a) providing a point server system, connectable to a computer network and accessed by way of a user terminal connected to the computer network comprising:
a user information database for storing user information, wherein the user information database comprises: a plurality of personal information for a user and a plurality of point information; and
a point information database for storing point information specified for at least one product or service; and
a serial number input means, provided in the user terminal for inputting serial numbers assigned to at least one of the products or services, wherein at least one serial number is input and sent using the serial number input means;
b) receiving the serial number for the product or service;
c) authenticating the user;
d) determining a plurality of points corresponding to the product or service from the point information database based on the serial number received in step (b); and
e) adding the determined number of points to the point information for the user into the user information database.

15. The method of claim 14, wherein the serial number input means is a barcode reader.

16. The method of claim 14, wherein the serial number input means is a digital data reading means for reading embedded information incorporated in digital data.

17. The method of claim 14, wherein the serial number input means is an image input.

18. The method of claim 14, wherein the serial number input means is a voice input.

19. The method of claim 14, wherein the computer network is selected from the group consisting of:
a) an Internet;
b) an intracompany local area network;
c) an intercompany local area network; and
d) a wide area network.
